(19) United States
(12) Patent Application Publication
(10) Pub. No.: US 2021/0342325 A1
(43) Pub. Date: Nov. 4, 2021

(54) MEMORY MANAGEMENT USING APPROXIMATED COUNT-MIN SKETCH DATA STRUCTURES

(71) Applicant: Fastly, Inc., San Francisco, CA (US)

(72) Inventor: Pierre-Louis Dubouilh, Berlin (DE)

(21) Appl. No.: 16/921,230

(22) Filed: Jul. 6, 2020

Related U.S. Application Data
(60) Provisional application No. 63/018,797, filed on May 1, 2020.

(51) Int. Cl. G06F 16/22; G06F 16/245; H04L 29/06; G06F 17/18

(52) U.S. Cl. CPC G06F 16/2282; G06F 17/18; H04L 69/22; G06F 16/245

(57) ABSTRACT

Disclosed herein are systems, methods, and software to use approximated counting with count-min sketch data structures. In one implementation, a computer may identify a value in a data object and determine whether a count identified in a count-min sketch data structure and associated with the value exceeds a threshold count. If the count does not exceed the threshold count, the computer may increase the count in a count-min sketch data structure. If the count does exceed the threshold, the computer may apply a probability function to determine whether to increase the count and, in response to the probability function indicating an increase to the count, increasing the count in the count-min sketch data structure.

### RELATED APPLICATIONS

This application hereby claims the benefit of and priority to U.S. Provisional Patent Application No. 63/018,797, titled “MEMORY MANAGEMENT USING APPROXIMATED COUNTING AND COUNT-MIN SKETCH DATA STRUCTURES,” filed May 1, 2020, and which is hereby incorporated by reference in its entirety.

### BACKGROUND

In computing systems, counters are used to provide various functions, such as identifying the frequency that a number or string of characters is used, a frequency that a type of request is generated or received, or for some other function. For example, counters may be used in a server environment to monitor the quantity of requests from various different internet protocol (IP) addresses. The counters may be used to identify fraudulent or malicious content requests, identify users that are requesting the most data from the server, or for some other purpose.

Although counters provide an important tool for computing systems, difficulties can arise in storing counters associated with multiple values. To more efficiently use the memory space of a computing system, some software implementations employ count-min sketch data structures, which are probabilistic data structures that serve a s a frequency table of values in a stream of data. In particular, a count-min sketch data structure uses hash functions to map value frequencies. Unlike a hash table that uses a single hash function, the count-min sketch data structure uses multiple hash functions that each correspond to a different portion, such as a column, in the data structure.

While the count-min sketch data structure permits a computing system to more efficiently use the memory space to maintain counts associated with a data stream, the data structure also has its own drawbacks. These drawbacks may include increased memory usage as the frequencies for the values increase, causing each entry in the data structure to use additional bits, unnecessary precision for the counts associated with the values, among other drawbacks.

### OVERVIEW

Technology is disclosed herein for using approximated counting with count-min sketch data structures. In one implementation, a method includes obtaining a value and determining whether a count associated with the value exceeds a threshold count based on a count-min sketch data structure. If the count associated with the value does not exceed the threshold count, the method further increases the count in the count-min sketch data structure. If the count associated with the value does exceed the threshold count, then the method applies a probability function to determine whether to increase the count and, in response to the probability function indicating an increase to the count, increases the count in the count-min data structure.

### BRIEF DESCRIPTION OF THE DRAWINGS

The following description and associated figures teach the best mode of the invention. For the purpose of teaching inventive principles, some conventional aspects of the best mode can be simplified or omitted. The following claims specify the scope of the invention. Note that some aspects of the best mode cannot fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates a computing environment to maintain counts associated with values according to an implementation.

FIG. 2 illustrates an update operation to maintain counts associated with values according to an implementation.

FIG. 3 illustrates an operational scenario to update a version of a count-min sketch data structure according to an implementation.

FIG. 4 illustrates an operational scenario to respond to count related queries according to an implementation.

FIG. 5 illustrates an operational scenario of updating a version of a count-min sketch and responding to address count queries using the count-min sketch according to an implementation.

FIG. 6 illustrates a computing system to maintain a version of a count-min sketch according to an implementation.

### DESCRIPTION

Technology is disclosed herein for counting values from objects using a form of count-min sketch data structures and approximated counting functions. In one example, a computing system may maintain a version of count-min sketch data structure (hereinafter “count-min sketch data structure” or “count-min sketch”) that indicates counts associated with different values. The values may comprise numerical values, may comprise strings of characters, or may comprise some other value. The count-min sketch data structure is structured as a table, similar to that of a hash table. In particular, while a hash table may use a single hash function to update values in the table, a count-min sketch data structure uses multiple hash functions, each for a different portion of the table, such as a column or row in the table. When a value is identified from an object, the hash functions may be applied to the value to determine changes within the count-min sketch, wherein the changes include increasing entries within the data structure identified from the hash functions. Each of the hash functions may be used to map the value to one or more entries within the data structure that correspond to the hash function.

Here, rather than maintaining a precise count for each of the values, a computing system may use approximated counts for counts that exceed a threshold value. For example, while desirable to maintain accurate counts up to the threshold value, counts that exceed that value will be estimated to limit the amount of memory space that is used by the count-min sketch. In at least one example, when a value is identified as part of a data stream, a computing system may determine whether a count associated with the value exceeds a threshold count based on a maintained count-min sketch data structure. In at least one example, the computing system may query the count-min sketch to obtain a count for the value. If the count associated with the value does not exceed the threshold count, then the computing system may increase the count in the count-min sketch data structure. In increasing the value, the hash functions may be applied to the value to determine entries in the count-min sketch that should be updated or increased.

If the count associated with the value does exceed the threshold count, then the computing system may apply a probability function to determine whether the count should be increased and, if dictated by the probability function, increase the count in the count-min data structure. The probability function serves as part of an approximated counting function or algorithm, which can be used to approximate the count once the threshold is reached. Rather than increasing the count each time that the value is identified in the data stream, the probability function may be used to increase the count at a pseudo-random frequency. In at least one example, the probability function may consider the current count and use probabilities to determine when the count should be increased to the next increment. As an example, using base 2, an estimated counter can provide estimated the counts of 1, 2, 4, 8, 16, 32, and all of the increasing powers of two. To increment from 4 to 8, the probability function may be used to increase the count at a probability of 0.25. Although the previous example used base 2 for an example approximate counting function, it should be understood that other approximations may be used, such as different bases (e.g. base 8, 10, etc.), different exponential or linear functions, or some other approximation function.

As the count-min sketch data structure is maintained, queries may be generated to the count-min sketch to determine counts associated with a particular value. For example, a count-min sketch data structure may be used by a computing system to monitor the internet protocol (IP) addresses requesting data from the computing system. A user may generate a query to determine a count associated with a particular IP address. In response to the request, the computing system may retrieve the count from the count-min sketch data structure and respond to the query based on the count. If the count does not exceed the threshold described above, then the count may be provided to the requesting user without further operations. If the count exceeds the threshold, the computing system may determine an approximated count based on the approximation function and respond to the query with the approximated count. In some implementations, for counts that exceed the threshold, the computing system may maintain a lookup data structure (or table) that can convert counts over the threshold to the approximated count.

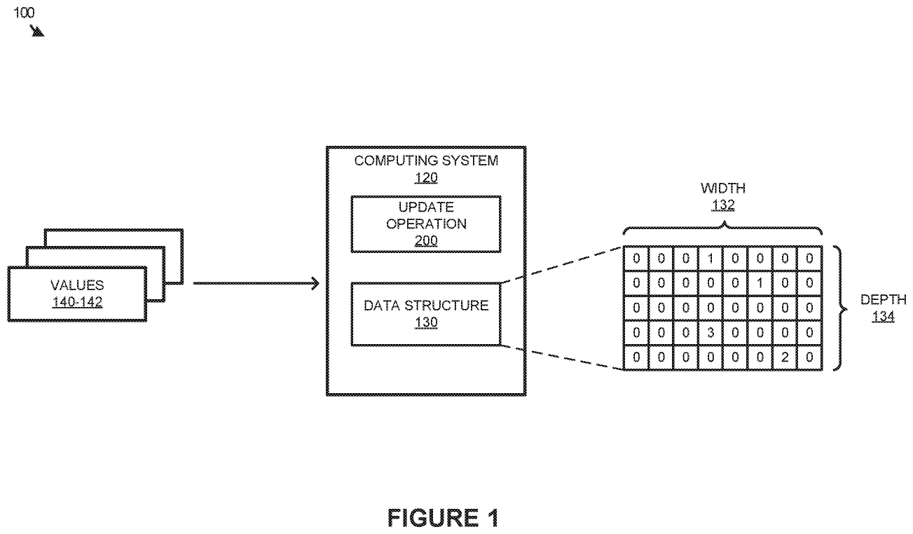

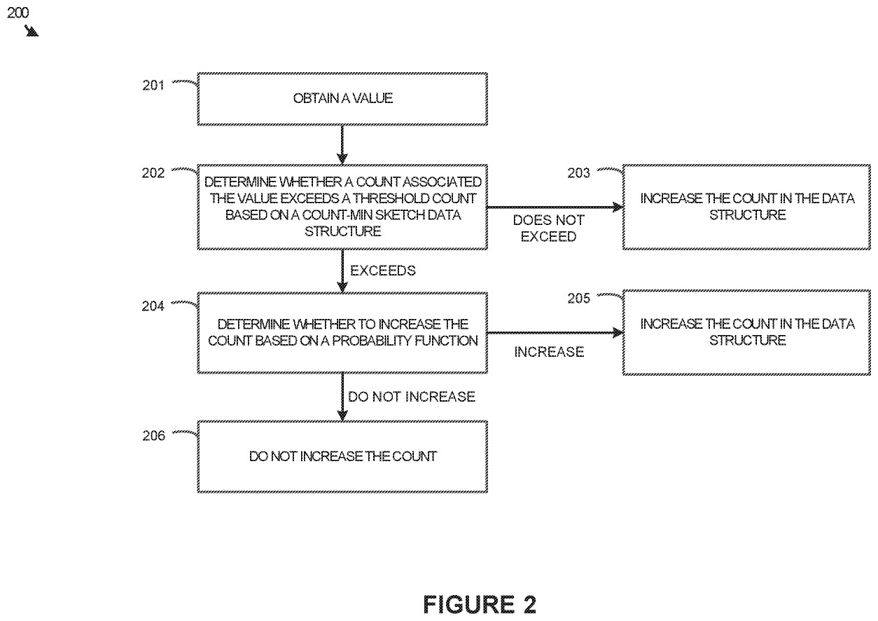

FIG. 1 illustrates a computing environment 100 to maintain counts associated with values according to an implementation. Computing environment 100 includes values 140-142 and computing system 120. Computing system 120 maintains data structure 130, which is representative of a count-min sketch and includes a width 132 and a depth 134. Computing system 120 performs update operation 200, which is described in further detail below with respect to FIG. 2. Although demonstrated with a width of eight entries and a depth of five entries, it should be understood that a count-min sketch data structure may comprise different widths and/or depths. These widths and depths may be defined by an administrator of the computing system and may be determined based on the quantity of different values expected for counting and the count size for each of the values.

In operation, computing system 120 obtains values 140-142 and updates data structure 130 based on the values. Values 140-142 may be extracted from packets, documents, databases, spreadsheets, or some other object. Values 140-142 may represent numerical values, strings of characters, or some other value. For example, values 140-142 may represent source IP addresses extracted from packets received by computing system 120. When a value is identified, update operation 200 is used to determine whether a count associated with the value should be increased. If the count is to be increased, update operation 200 may apply hash functions that correspond to data structure 130 and increase entries in data structure 130 based on the hash functions. As data structure 130 is maintained using update operation 200, a query may be generated for a count associated with a particular value. Computing system 120 may then respond to the query based on the count identified in data structure 130 and, if required, the applicable count approximation function required for counts that exceed a threshold count.

FIG. 2 illustrates an update operation 200 to maintain counts associated with values according to an implementation. The steps of operation 200 are referenced parenthetically in the paragraphs that follow with reference to elements of computing environment 100 FIG. 1.

As depicted, operation 200 includes obtaining (201) a value from a data stream. The value may be extracted from a packet, a document, a spreadsheet, a database, or some other object. Once the value is obtained, operation 200 determines (202) whether a count associated with the value exceeds a threshold count based on a count-min data structure. In some examples, computing system 120 may determine the count associated with the value using data structure 130 and compare the obtained value to the threshold count value. The threshold count may be defined by an administrator associated with computing system 120, may be determined based on one or more previous counts, or may be based on some other factor. For example, in determining the threshold count, a computing system may identify a max count that ninety-five percent of values for a previous count were under, then may assign the max count as the threshold count for the new values.

If update operation 200 determines that the count associated with the value does not exceed the threshold count, operation 200 may increase (203) the count in the count-min sketch data structure associated with the value. For example, when value 140 is identified, operation 200 may obtain a count for value 140 from data structure 130. When the count does not exceed the threshold count, operation 200 may update data structure 130 by increasing the count for value 140. This update may include applying the hashes to value 140 to identify entries in data structure 130 to be increased.

If update operation 200 determines that the count associated with the value does exceed the threshold count, operation 200 will apply (204) a probability function to determine whether to increase the count. In applying the probability function, operation 200 may identify the count associated with the value from data structure 130 and determine a probability that the count should be increased (count+1). The probability function may then be applied to determine whether to increase the count, wherein the probability function may be based on the approximation function or algorithm used to approximate the count. If the probability function indicates that the count is to be increased, operation 200 increases (205) the count in the count-min sketch data structure by applying the hashes to the value and increasing entries in the data structure that correspond to the hashes. In contrast, if the probability function does not indicate that the count should be increased, operation 200 will not modify (206) or increase the count associated with the value.

As counts are maintained in the count-min sketch data structure, queries may be generated to determine the counts associated with specific values. In some implementations, when a query is received for a particular value, computing system 120 may obtain the current count for the value from data structure 130. If the obtained count does not exceed the threshold, then the count obtained from data structure 130 may be used to respond to the query. However, if the count does exceed the threshold, then an approximated count may be determined using an approximation counting function or algorithm. In some implementations, rather than applying the approximation function in real time, a lookup table may be generated using the approximation function that can map approximated counts with counts identified from data structure 130. For example, if a count is identified from data structure 130 that exceeds the threshold count, the count may be mapped to an approximated count value in the lookup table, which is larger than the count. In some implementations, the approximated count may comprise a base 2, base 10, or some other exponential form of approximated counting.

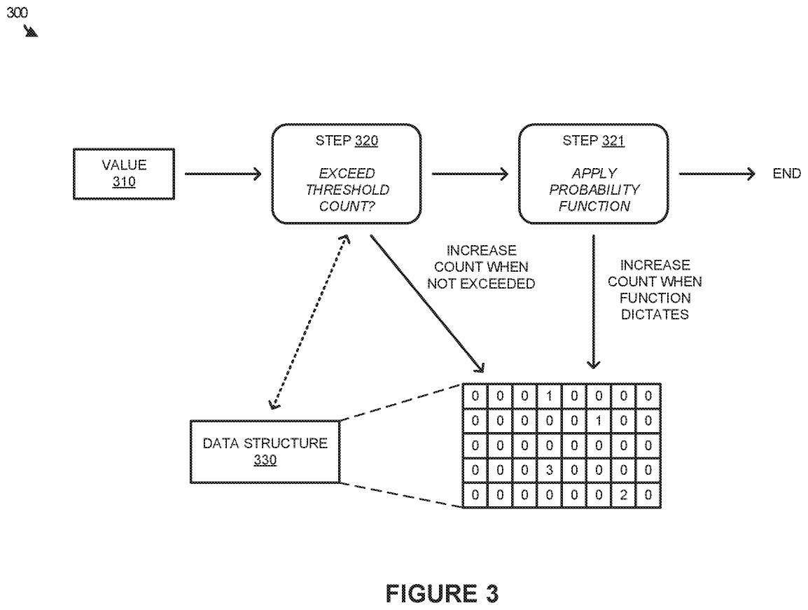

FIG. 3 illustrates an operational scenario 300 to update a count-min sketch data structure according to an implementation. Operational scenario 300 includes value 310, steps 320-321, and data structure 330, which is representative of a count-min sketch data structure to count values identified from different objects. Steps 320-321 may be implemented on a desktop computing system, server computing system, or some other computing system.

In operation, value 310 is identified or obtained from an object at a computing system, and the computing system performs step 320 to determine whether a current count associated with value 310 exceeds a threshold count. If the current count does not exceed the threshold, step 320 will increase the count in data structure 330. In increasing the count, the computing system may apply hashes associated with data structure 330 to identify entries that correspond to the value and will increase the value for each of the entries.

If the count associated with value 310 exceeds the threshold count, the computing system then performs step 321, wherein step 321 applies a probability function to determine whether or not to increase the count associated with value 310. In some implementations, the probability function corresponds to an approximated counting algorithm, wherein the probability function may identify the current count for value 310 and determine a probability that the count should be increased from the current value to the next value. Using a simplified example of a base 2 approximated counting algorithm, the step from 4 to 8 may require a probability of 0.25 for increasing the count. Thus, in some instances, the count for a value may be increased, while other instances, the count for the value may not be increased.

When the probability function indicates that the count should be increased, step 321 will may apply hashes associated with data structure 330 to identify entries that correspond to the value and will increase the value for each of the entries. As an illustrative example, value 310 may correspond to an IP address extracted from a packet received from the computing system. The hashes may be applied to the IP address to determine entries in data structure 330 that correspond to the IP address and may increase each of the entries.

As data structure 330 is updated, the computing system may then respond to queries that request counts associated with different values. When the count for a value does not exceed the threshold, then the count may be provided as a response to the query. However, when the count exceeds the threshold, the computing system may identify an approximated count associated with the count and respond to the query using the approximated count. In some examples, approximated count may comprise a form of an exponential function, a linear function, or some other approximated count function or algorithm. The algorithm may define the probability function associated with increasing the count in the data structure.

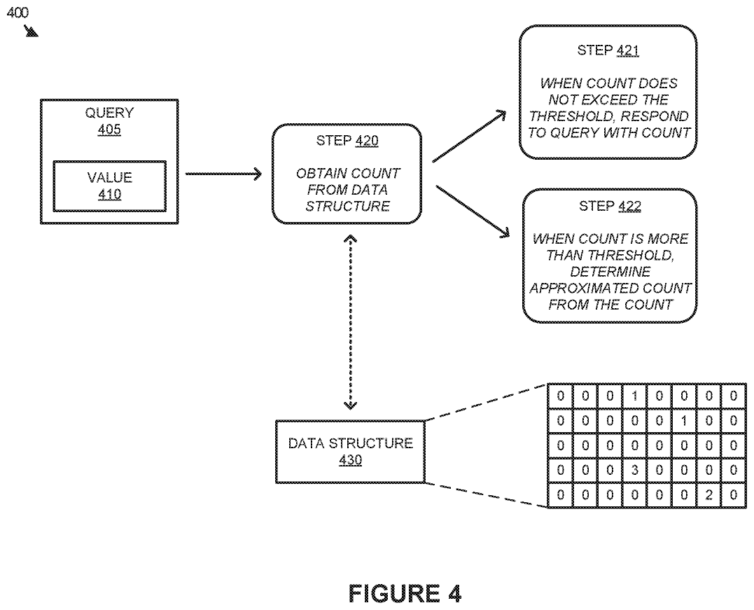

FIG. 4 illustrates an operational scenario 400 to respond to count related queries according to an implementation. Operational scenario 400 includes query 405 with value 410, steps 420-422, and data structure 430, which is representative of a count-min sketch. Steps 420-422 may be performed by a desktop computing system, server computing system, or some other computing system.

In operation, a computing system may maintain data structure 430 to count occurrences of values in a data stream, wherein the values may be extracted from documents, packets, spreadsheets, or some other object. While maintaining data structure 430, a query may be generated to identify a count associated with a value. The query may be generated by a user of the computing system, another service, such as a bot detection service, or some other source. Here, query 405 is generated in association with value 410 that is received by the computing system. In response to the query, the computing system may perform step 420 that obtains a count from the data structure. In some implementations, the computing system may apply the hashes associated with data structure 430 to identify entries in data structure 430 associated with value 410. From the entries, the computing system may determine a count associated with value 410.

After the count is obtained, steps 421 or 422 may be performed. The computing system may implement step 421 when the retrieved count does not exceed the threshold and may respond to the query using the count from data structure 430. In contrast, the computing system may employ step 422 when the count does exceed the threshold and may determine an approximated count from the retrieved count. In determining the approximated count, the count obtained from data structure 430 may be applied to an approximation counting algorithm or function, which can be exponential, linear, or some other function. In some implementations, rather than executing the function in response to the request, a lookup table may be generated to match counts obtained from data structure 430 to approximated counts. Once the approximated count is identified, the approximated count may be supplied as the count to respond to the query.

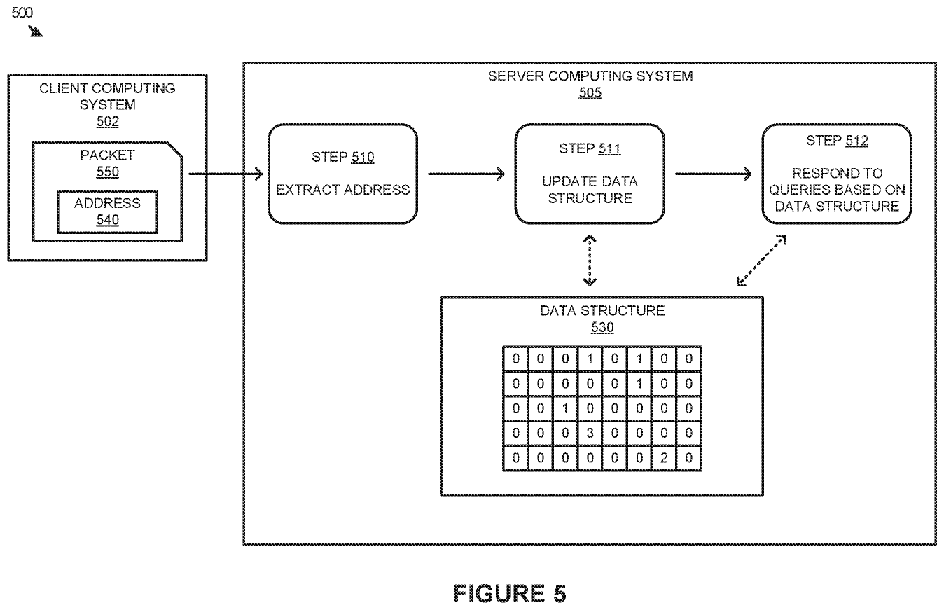

FIG. 5 illustrates an operational scenario 500 of updating a count-min sketch and responding to queries using the count-min sketch according to an implementation. Operational scenario 500 includes a client computing system 502 and a server computing system 505. Client computing system 502 includes packet 550 and address 540. Server computing system 505 includes steps 510-512 and data structure 530, which is representative of a count-min sketch data structure.

In operation client computing system 502 generates packet 150 that is delivered to server computing system 505. The packet may comprise a User Datagram Protocol (UDP) packet, Transmission Control Protocol (TCP), or some other protocol packet. When the packet is received, server computing system 505 may, at step 510, extract address 540, which is representative of a source IP address associated with client computing system 502. Once address 540 is extracted from the packet, server computing system 505 may update data structure 530, at step 511. In some implementations in updating data structure 530, server computing system 505 may identify a count associated with address 540 using data structure 530. If the count does not exceed the threshold, server computing system 505 may increase the count in data structure 530. In increasing the count, server computing system 505 may apply hash functions address 540 to identify entries in data structure 530 that correspond to address 540. Each of the hash functions may be used to map address 540 to one or more of the entries in data structure 530. Once the entries are identified, each of the entries may be increased to correspond to the count increase for address 540.

If the count for address 540 identified from data structure 530 does exceed the threshold, step 511 may apply a probability function to determine whether the count should be increased in data structure 530. In some implementations, the probability function corresponds to an approximated counting algorithm, wherein the approximated counting algorithm may comprise an exponential counting approximation, linear approximation, or some other approximation. Thus, each time the address is identified, server computing system 505 may only increase the count when dictated by the probability function.

As the data structure is updated, server computing system 505 may respond queries based on data structure 530, at step 512. In some implementations, a user or another process may generate a query for the count associated with an address, such as address 540. In response the request, server computing system 505 may apply the hashes to the address to identify entries in the data structure related to the address and determine a count from the identified entries. Once a count is identified, server computing system 505 may determine whether the count exceeds the threshold count. If the count does not exceed the threshold count, then the query may be responded to with the count. If the count does exceed the threshold count, then server computing system 505 may apply an approximation algorithm or function to determine an approximated count associated with the address in the query, wherein the approximation may use exponentials, linear growth, or some other approximation function.

Although described in the previous examples using a threshold to trigger the use of the approximated counting, it should be understood that similar operations may be performed without the use of a threshold. In an example, when a value is obtained as part of a data stream, the computing system may perform a probability function to determine whether the count should be increased for that value. Advantageously, if only approximated counts are required, the computing system may reserve system resources for other operations.

In some implementations, the parameters (width, depth, entry size, etc.) for the count-min sketch and the threshold count may be defined by an administrator based on the requirements of the counts. The factors that can be considered may include the quantity of values to be counted (e.g., number of IP addresses to be counted), the count size for each of the values, the accuracy required for each of the counts, or some other factor. The parameters may be defined directly by an administrator or may be determined at least in part from requirements for the count, such as an accuracy requirement, a quantity of values to be counted, count size for the values, or some other requirement. In some examples, the information may be provided by an administrator and the parameters for the data structure and threshold may be generated.

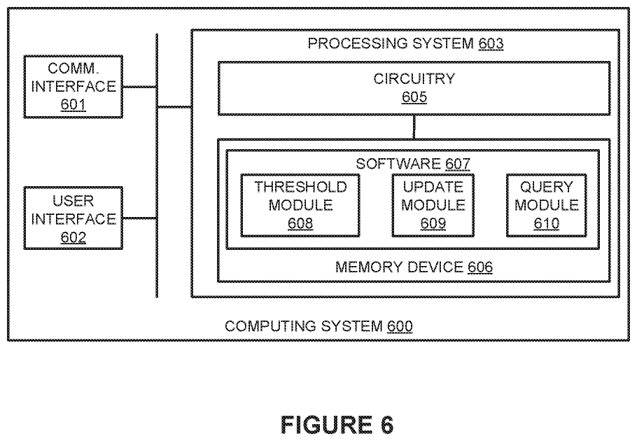

FIG. 6 illustrates a computing system 600 to maintain a count-min sketch according to an implementation. Computing system 600 is representative of any computing system or systems with which the various operational architectures, processes, scenarios, and sequences disclosed herein for managing a count-min data structure. Computing system 600 may comprise a server or a cache node in a content delivery network, although other computing system examples may exist. Computing system 600 may be an example of computing system 120 from FIG. 1 or server computing system 505 from FIG. 5.

Computing system 600 comprises communication interface 601, user interface 602, and processing system 603. Processing system 603 is linked to communication interface 601 and user interface 602. Processing system 603 includes processing circuitry 605 and memory device 606 that stores operating software 607. Computing system 600 may include other well-known components such as a battery and enclosure that are not shown for clarity. Computing system 600 may comprise one or more server computing systems, desktop computing systems, laptop computing systems, or any other computing system, including combinations thereof.

Communication interface 601 comprises components that communicate over communication links, such as network cards, ports, radio frequency (RF), processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols, communication signaling, or some other communication format—including combinations thereof. In some implementations, communication interface 601 may be used to communicate with end user or client computing systems that request content from computing system 600. Communication interface 601 may further communicate with administrative computing systems capable of generating queries in regard to counts maintained by the computing system.

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples.

Processing circuitry 605 comprises microprocessor and other circuitry that retrieves and executes operating software 607 from memory device 606. Memory device 606 comprises a non-transitory storage medium, such as a disk drive, flash drive, data storage circuitry, or some other memory apparatus. Processing circuitry 605 is typically mounted on a circuit board that may also hold memory device 606 and portions of communication interface 601 and user interface 602. Operating software 607 comprises computer programs, firmware, or some other form of machine-readable processing instructions. Operating software 607 includes threshold module 608, update module 609, and query module 610, although any number of software modules may provide the same operation. Operating software 607 may further include an operating system, utilities, drivers, network interfaces, applications, or some other type of software. When executed by processing circuitry 605, operating software 607 directs processing system 603 to operate computing system 600 as described herein.

In at least one implementation, threshold module 608 directs processing system 603 to obtain a value from a data stream, wherein the value may be extracted from a document, spreadsheet, packet, or some other object. Once the value is obtained, threshold module 608 directs processing system to determine whether a count associated with the value exceeds a threshold count based on a count-min data structure. In some implementations, the computing system may use the hashes for the data structure to identify entries associated with the value and may use the entries to determine a current count for the value. The threshold may be defined by an administrator, may be determined based on previous counts, or may be determined in any other manner.

If the count associated with the value does not exceed the threshold count, update module 609 directs processing system 603 to increase the count in the count-min sketch data structure. In increasing the count, update module 609 may identify relevant entries in the data structure using the hashes associated with the data structure and increase the value in each of the entries. In contrast, if the count associated with the value does exceed the threshold count, update module 609 my apply a probability function to determine whether to increase the count and, in response to the probability function indicating an increase to the count, increasing the count in the count-min sketch data structure. In some implementations, an administrator associated with computing system 600 may generate an approximation algorithm that can use the count from the data structure and apply it to an exponential, liner, or some other approximated counting algorithm. Based on the algorithm, a probability function may be used to determine when the count in the data structure should be increased.

As the data structure is maintained, query module 610 directs processing system 603 to receive and respond to queries associated with the counts. In at least one implementation, query module 610 may obtain a request for a count associated with a particular value from a user or another process (e.g., a blacklisting process for IP addresses). In response to the request, query module 610 may retrieve the count for value from the count-min sketch data structure and determine whether the retrieved count exceeds the threshold. If the retrieved count does not exceed the threshold, then the response to the query may include the retrieved count. However, if the retrieved count does exceed the threshold, query module 610 may apply the approximation algorithm or function to determine an approximated count and respond to the query using the approximated count. In some implementations, rather than executing the function in real time, a lookup table may be generated and maintained by computing system 600, such that identified counts from the count-min sketch data structure may be mapped to approximated counts.

In some implementations, an administrator associated with computing system 600 may define parameters (width, depth, entry size, etc.) for the count-min sketch data structure and the threshold for triggering the approximated counting function. These parameters may be determined based on the quantity of different values expected, the total counts for each of the values, the accuracy desired for the counts, or some other factor.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
obtaining a value;
determining whether a count associated with the value exceeds a threshold count based on a count-min sketch data structure;
if the count associated with the value does not exceed the threshold count, increasing the count in the count-min sketch data structure;
if the count associated with the value does exceed the threshold count:
applying a probability function to determine whether to increase the count; and
in response to the probability function indicating an increase to the count, increasing the count in the count-min sketch data structure.

2. The method of claim 1, wherein the value comprises a numerical value or string of characters.

3. The method of claim 1 further comprising:
receiving a data packet comprising the value; and
wherein obtaining the value comprises extracting the value from the data packet.

4. The method of claim 3, wherein the value comprises an internet protocol (IP) address.

5. The method of claim 1 further comprising:
obtaining a query for the count associated with the value;
determining that the count does not exceed the threshold count based on the count-min sketch data structure; and
using the count to respond to the query.

6. The method of claim 1 further comprising:
obtaining a query for the count associated with the value;
determining that the count exceeds the threshold count based on the count-min sketch data structure;
determining an approximated count using the count from the count-min sketch data structure and an approximated count function; and
using the approximated count as the count to respond to the query.

7. The method of claim 1 further comprising:
determining the threshold value based on previous counts associated with one or more values.

8. The method of claim 1 further comprising:
obtaining a second value;
determining whether a second count associated with the second value exceeds the threshold count based on the count-min sketch data structure;
if the second count associated with the second value does not exceed the threshold count, increasing the second count in the count-min sketch data structure;
if the second count associated with the second value does exceed the threshold count:
applying the probability function to determine whether to increase the second count; and
in response to the probability function indicating an increase to the second count, increasing the second count in the count-min data structure.

9. A computing apparatus comprising:
a storage system;
a processing system operatively coupled to the storage system; and
program instructions stored on the storage system that, when executed by the processing system, direct the processing system to:
obtain a value;
determine whether a count associated with the value exceeds a threshold count based on a count-min sketch data structure;
if the count associated with the value does not exceed the threshold count, increase the count in the count-min sketch data structure;
if the count associated with the value does exceed the threshold count:
apply a probability function to determine whether to increase the count; and
in response to the probability function indicating an increase to the count, increase the count in the count-min sketch data structure.

10. The computing apparatus of claim 9, wherein the value comprises a numerical value or a string of characters.

11. The computing apparatus of claim 9, wherein the program instructions further direct the processing system to:
receive a data packet comprising the value; and
wherein obtaining the value comprises extracting the value from the data packet.

12. The computing apparatus of claim 11, wherein the value comprises an internet protocol (IP) address.

13. The computing apparatus of claim 9, wherein the program instructions further direct the processing system to:
obtain a query for the count associated with the value;
determine that the count does not exceed the threshold count based on the count-min sketch data structure; and
use the count to respond to the query.

14. The computing apparatus of claim 9, wherein the program instructions further direct the processing system to:
obtain a query for the count associated with the value;
determine that the count exceeds the threshold count based on the count-min sketch data structure;
determine an approximated count using the count from the count-min sketch data structure and an approximated count function; and
use the approximated count as the count to respond to the query.

15. The computing apparatus of claim 9, wherein the program instructions further direct the processing system to determine the threshold value based on previous counts associated with one or more values.

16. The computing apparatus of claim 9, wherein the program instructions further direct the processing system to:
obtain a second value;
determine whether a second count associated with the second value exceeds the threshold count based on the count-min sketch data structure;
if the second count associated with the second value does not exceed the threshold count, increase the second count in the count-min sketch data structure;
if the second count associated with the second value does exceed the threshold count:
applying the probability function to determine whether to increase the second count; and
in response to the probability function indicating an increase to the second count, increase the second count in the count-min data structure.

17. A method of operating a computer comprising:
receiving a packet;
identifying a source internet protocol (IP) address in the packet;
determining whether a count associated with the source IP address exceeds a threshold count based on a count-min sketch data structure;
if the count associated with the source IP address does not exceed the threshold count, increasing the count in the count-min sketch data structure;
if the count associated with the value does exceed the threshold count:
applying a probability function to determine whether to increase the count; and
in response to the probability function indicating an increase to the count, increasing the count in the count-min sketch data structure;
obtaining a query for the count associated with the source IP address; and
responding to the query based on the count in the count-min sketch data structure.

18. The method of claim 17, wherein responding to the query based on the count in the count-min sketch data structure comprises:
determining an approximated count using the count from the count-min sketch data structure and an approximated count function; and
using the approximated count as the count to respond to the query.

19. The method of claim 17 further comprising:
determining the threshold value based on previous counts associated with one or more source IP addresses.

20. The method of claim 17, wherein responding to the query based on the count in the count-min sketch data structure comprises:
determining that the count in the count-min sketch data structure does not exceed the threshold count; and
using the count to respond to the query.
